(19) United States
(12) Patent Application Publication
(10) Pub. No.: US 2024/0003455 A1
(43) Pub. Date: Jan. 4, 2024

(54) HYBRID DIRECT TAP CORPORATION STOP

(71) Applicant: A. Y. McDonald Mfg. Co., Dubuque, IA (US)

(72) Inventor: Sebastian Yaklin, Dubuque, IA (US)

(21) Appl. No.: 18/216,210

(22) Filed: Jun. 29, 2023

Related U.S. Application Data
(60) Provisional application No. 63/357,241, filed on Jun. 30, 2022.

(51) Int. Cl. F16K 27/06

(52) U.S. Cl. CPC F16K 27/067

(57) ABSTRACT

A fitting having a body with an inlet and an outlet, and a saddle through which a part of the fitting passes and in which it seals by use of gaskets in annular grooves. The fitting when threaded into a tapped hole in a main pipe draws the saddle toward the pipe, compressing a gasket against the pipe surface, thereby sealing the fitting to the main pipe without requiring the sealing of its threads.

### CROSS-REFERENCE TO RELATED APPLICATIONS

This is a non-provisional application which claims priority from U.S. Provisional Patent Application No. 63/357,241, titled “Hybrid Direct Tap Corporation Stop”, filed Jun. 30, 2022.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to a fitting for making a connection to the wall of a main pipe, and in particular to corporation stops adapted to connect to the wall of a main pipe.

### BACKGROUND OF THE INVENTION

Fittings for the connection of service lines to mains may include corporation stops, T's, Y's, adapters and the like. These service line connecting fittings are typically received in a threaded hole on the main pipe, the threads thereby fixing the fitting to the main. Additionally, the threads may be the sealing feature.

As illustrated in FIG. 1, a main pipe (or pipe main) 20′ have typically had corporation stops 12′ attached by tapered threads 13′ functioning both as a mechanical connection and a pressure seal, sealing around a band of thread contact area. Thread sealant has also been used to fill voids between threads. However, such attachments to thinner pipe wall sections (as is the case with ductile iron pipes) yield a reduction of thread sealing contact area compared to thicker sections. Further, smaller pipe diameters yield fewer continuous turns of thread engagement compared to larger diameters with such attachments, all of which can increase the likelihood of leakage at the connection.

As illustrated in FIG. 2, some service line connections to main pipes 20′ (e.g., a water main) include a corporation stop 12″ secured to a service saddle 15′ which surrounds the main pipe 20′. The service saddle provides a sealing function against the outside surface of the water main while still typically requiring the installation of a corporation stop 12′ (e.g., a valve or other fitting) into the threaded outlet 17′ of the service saddle 15′.

Various other connection fittings are also known from prior art, including non-tapping connections which rely upon retention devices that are flared inside the pipe, as well as fittings that are threadably engaged with the water main and assisted in sealing by additional operation of a nut to compress a gasket against the pipe wall. There is also a known structure which utilizes a platelike saddle to seal with annular packing against the main pipe outside diameter and the corporation stop body. None of these prior inventions have proven satisfactory.

See, for example, Yano U.S. Pat. No. 3,638,906.

### SUMMARY OF THE INVENTION

Disclosed herein is a fitting which may be utilized in connecting a service line to a main pipe.

In one aspect of the disclosure, a fitting for a corporation stop on a main pipe adapted to secure in a threaded opening in the main pipe is provided, including a corporation stop body and a corporation stop saddle. The corporation stop body has an inner passage between an inlet and an outlet end, a threaded outer surface on the inlet end, an outer shoulder facing the inlet end, and an annular outer surface adjacent to and coaxial with the threaded outer surface. The corporation stop saddle is around the stop body annular outer surface whereby the corporation stop body and corporation stop saddle are rotatable relative to each other around an axis. The corporation stop saddle also has a face around the corporation stop body adapted to fit the contour of a main pipe. A first seal is around the corporation stop body on the corporation stop saddle face, and a second seal is between the corporation stop body annular outer surface and the corporation stop saddle. When the corporation stop body is screwed into a main pipe threaded opening, the corporation stop body outer shoulder presses the corporation stop saddle axially against the main pipe to secure against leaking past the first seal.

In one form of this aspect of the disclosure, the first and second seals are gaskets, and in a further form the first and second gaskets are O-rings.

In another form of this aspect of the disclosure, a valve is in the corporation stop body inner passage between the inlet and outlet ends.

In still another form of this aspect of the disclosure, the corporation stop saddle is securable against rotation around the axis when the corporation stop body rotates around the axis.

Yet another form of the disclosed invention comprises a main pipe having at least one of these fittings.

In still another form of this aspect of the disclosure, the corporation stop body thread is straight, and in an alternate form, the corporation stop body thread is tapered.

In yet another form of this aspect of the disclosure, an annular recess is in the corporation stop saddle face wherein the first seal is in the stop saddle face annular recess.

In another aspect of the disclosure, a corporation stop body is installed on a main pipe or the like by using a suitable drilling and tapping machine. Specifically, a drill and tapping machine saddle may be secured on a main pipe whereby the corporation stop saddle is between the machine saddle and the main pipe, and a gasket is between the corporation stop saddle and the main pipe. The main pipe may then be drilled and tapped using the drilling and tapping machine to form a threaded opening through the main pipe. The corporation stop body is then inserted into a corporation stop saddle cylindrical opening and, while securing the corporation stop saddle against rotating, the corporation stop body is rotated to screw it into the main pipe threaded opening whereby the corporation stop body when tightened bears against the shoulder of the corporation stop saddle to secure the gasket around the central opening and between the corporation stop saddle and the main pipe. Finally, the drilling and tapping machine including the drilling and tapping machine saddle may be removed.

In a further form, at least one gasket is provided between the corporation stop saddle cylindrical opening and the corporation stop body in the corporation stop saddle cylindrical opening.

In still another aspect of the invention, a corporation stop body is installed on a main pipe using a drilling and tapping machine, Specifically, a drilling and tapping machine and a corporation stop saddle are connected on the main pipe with a gasket between the connection of the corporation stop saddle and the drilling and tapping machine, wherein the corporation stop saddle has a cylindrical opening. The main pipe is drilled and tapped using the drilling and tapping machine to form a threaded opening through the main pipe. The corporation stop body is then inserted into the corporation stop saddle cylindrical opening and, while securing the corporation stop saddle against rotating, the corporation stop body is rotated to screw it into the main pipe threaded opening whereby the corporation stop body when screwed into the main pipe threaded opening bears against a shoulder of the corporation stop saddle to secure the gasket around the central opening and between the corporation stop saddle and the main pipe. The drilling and tapping machine is then removed.

In another form, at least one gasket is provided between the corporation stop saddle cylindrical opening and the corporation stop body in the corporation stop saddle cylindrical opening.

In still another form, the connecting step comprises clamping overlapping lips of the machine and the corporation stop saddle together with a gasket secured between the overlapping lips.

Other objects, features, and advantages of the invention will become apparent from a review of the entire specification, including the appended claims and drawings.

### BRIEF DESCRIPTION OF THE DRAWINGS

FIG. 1 is a longitudinal sectional view illustrating an example of a prior art connection of a corporation stop to a water main;

FIG. 2 is a longitudinal sectional view illustrating another example of a prior art connection of a corporation stop to a water main;

FIG. 3 is a longitudinal sectional view of an embodiment of a fitting attached to a main according to one form of the present invention;

FIGS. 4A and 4B are sectional views of alternate forms of fittings according to the present invention, including different tapping machine saddles which temporarily secure the fitting to a water main at the start of a tapping operation;

FIG. 5 is a longitudinal sectional view of an embodiment of the fitting within a simplified drilling and tapping machine;

FIG. 6 is a perspective view of a section of main pipe with a corporation stop attached thereto according to one form of the invention;

FIG. 7 is a perspective, partial sectional view of the fitting saddle according to one form of the invention;

FIG. 8 is a side view of the fitting saddle according to one form of the invention;

FIG. 9 is a perspective view of the tapping machine saddle according to one form of the invention;

FIG. 10 is an exploded view of the fitting according to one form of the invention;

FIG. 11 is a longitudinal sectional view of another embodiment of the fitting with an alternate drilling and tapping machine; and

FIG. 12 is a longitudinal sectional view of yet another embodiment of the fitting with an alternate drilling and tapping machine configuration.

### DETAILED DESCRIPTION OF THE PREFERRED EMBODIMENT

Though variously described herein with specific connections (e.g., corporation stops), the fittings described herein may be used in a wide variety of applications, particularly for the connection of service lines to mains including not only corporation stops but also T's, Y's, adapters and the like. Therefore, claims and descriptions herein mentioning, for example, corporation stops should be understood to include T's, Y's, adapters and the like.

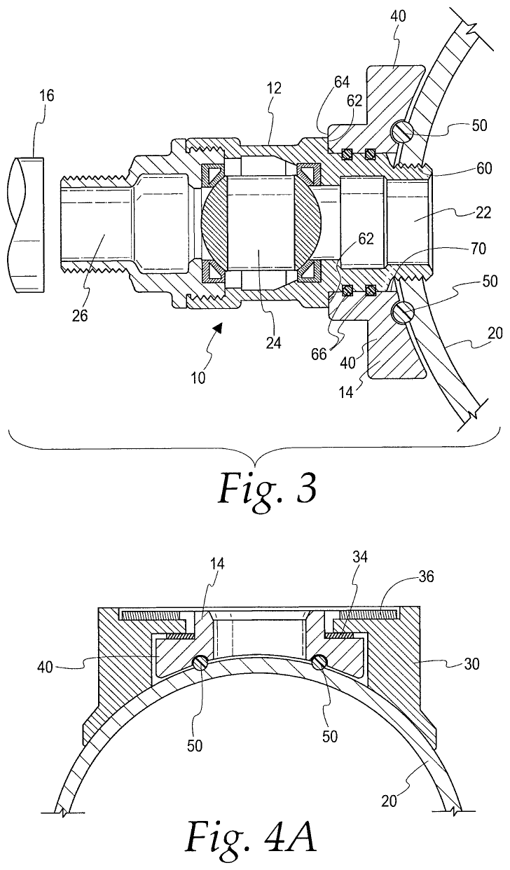

FIG. 3 illustrates an advantageous form of the invention disclosed herein including a fitting 10 comprising a corporation stop body 12 and a corporation stop saddle 14 which may be used to advantageously connect a service line 16 to a main pipe 20. The corporation stop body 12 has an inlet 22, a valve section 24, and an outlet 26. The valve section 24 may be of any structure/type suitable for controlling flow of fluid (e.g., water) through the corporation stop body 12 (e.g., a ball valve as illustrated in FIG. 3 or a plug valve). The outlet 26 may also be of any structure/type suitable for connecting to a service line 16 (e.g., a compression gasket type, a flare connection, a threaded end, a stab connection, etc.).

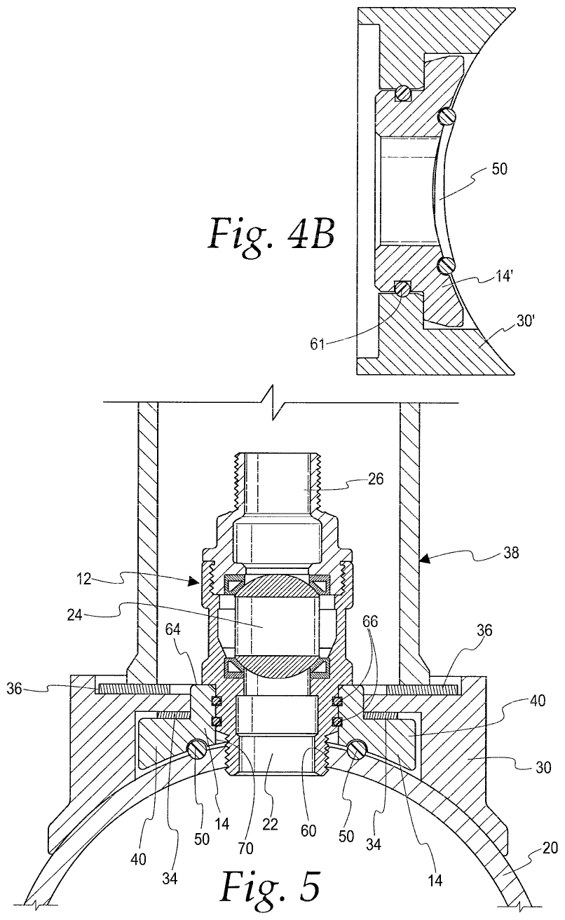

The fitting 10 may be advantageously installed by placing a contour matching corporation stop saddle 14 on the contoured surface of the main pipe 20. A suitable tapping machine saddle 30 and accompanying gaskets 34, 36 are placed over the corporation stop saddle 14 (see FIGS. 4A and 10). The rest of the tapping machine 38 is then placed on the tapping machine saddle gasket 36 (see FIG. 5) and secured to the main pipe 20 in a suitable manner, such as with a strap or chain. The drilling and tapping operation is then suitably carried out in the way as prescribed by the function of the tapping machine 38. Following that, the corporation stop body 12 may be installed using the drilling and tapping machine as prescribed for the machine 38, including rotating the corporation stop body 12 to screw the stop body inlet 22 into the threaded bore 60 in the pipe 20.

FIG. 4B illustrates another configuration of corporation stop saddle 14′ and machine saddle 30′ as may alternatively be used with different drilling and tapping machines, with a gasket/seal 61 between an outer surface of the corporation stop saddle 14′ and an inner surface of the machine saddle 30′ to prevent leaking from the machine during installation. (Note that when the corporation stop body 12 is installed, gaskets 66 such as illustrated in FIG. 3 would be included and the gasket/seal 61 illustrated in FIG. 4B have no function after the removal of the machine saddle 30′.

As best seen in FIG. 3, the corporation stop body 12 when tightened into the threaded bore 60 in the wall of the main pipe 20 has a radially extending face 62 which bears against the shoulder 64 of the corporation stop saddle 14, and therefore the corporation stop saddle 14 is pressed toward the outer wall of the pipe 20. A suitable saddle seal or gasket 50 (such as an O-ring) is provided between the stop saddle 14 and the pipe 20 and surrounding the stop body inlet 22, whereby the pressing of the stop saddle 14 toward the main pipe 20 forms a seal preventing any leaking of fluid through the tap hole and out between the stop saddle and outer wall of the pipe 20. The stop saddle shoulder 64 and stop body radially extending face 62 are preferably annular and may be flat or conical in either direction (tapered inward or outward)—any shape in which the stop saddle 14 is biased toward the pipe 20 as described.

Additionally, the corporation stop body inlet 22 outside diameter closely fits within the diameter of the bore 70 in the corporation stop saddle 14, with one or more gaskets 66 positioned between the body inlet 22 and the saddle bore 70. The gasket(s) 66 are sufficiently configured to wipe away debris incidental to the drilling and tapping process as the corporation stop 12 is installed into the corporation stop saddle 14, and further function to form seals which prevent leaking of fluid through the tap hole and out between the stop body 12 and the stop saddle 14.

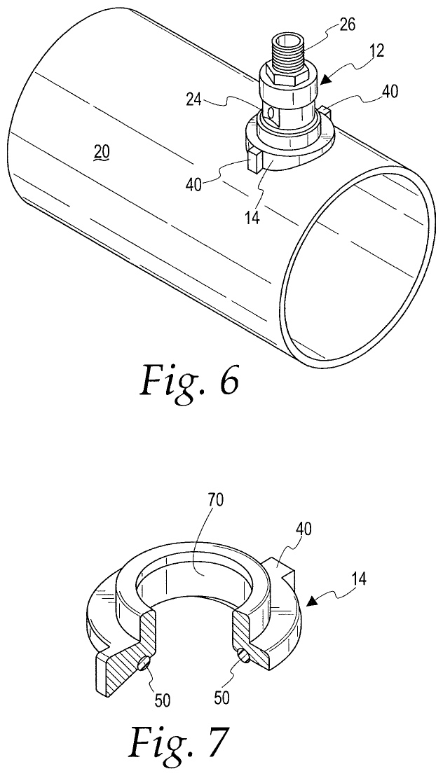

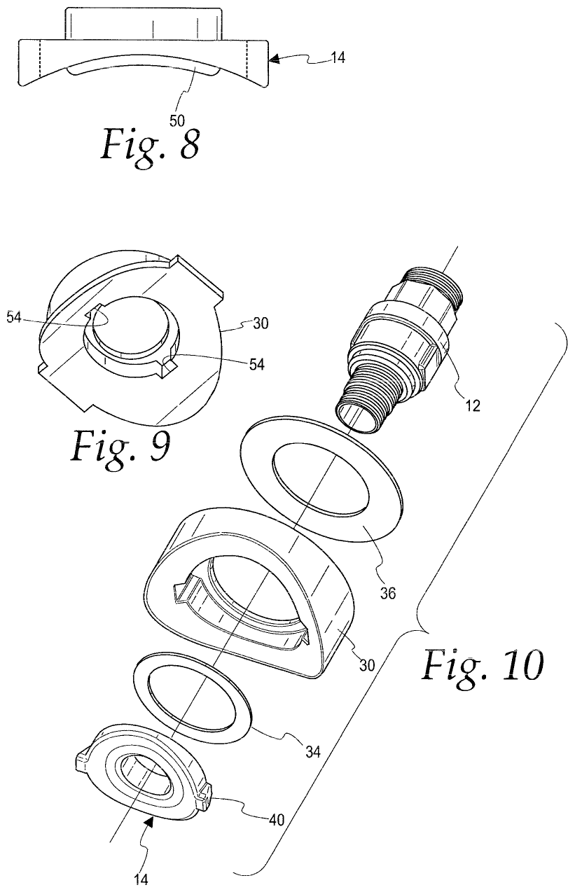

One or more alignment features 40 may also be advantageously used to ensure accurate positioning of the saddle 14 and ensure that the saddle 14 does not rotate as the corporation stop body 12 is installed through the saddle 14 and into the main pipe 20. That is, as particularly illustrated in FIGS. 6 and 7, two alignment features (e.g., wings) 40 are provided on the outside diameter of the corporation stop saddle 14. The saddle 14 is shaped to correspond to the outside diameter (contour) of the main pipe 20, thereby holding the saddle gasket 50 in close conformity to the main pipe contour. The wings 40 of the corporation stop saddle 14 engage with one or more complementary features 54 on the tapping machine saddle 30 (see, e.g., FIG. 7) to secure the stop saddle 14 against rotating when, for example, the corporation stop body 12 is rotated when installing. The tapping machine saddle 30 is similar in function to that of a traditional tapping machine saddle as known in the art; however, its alignment features are an advantageous part of this invention and advantageous to the function of the invention disclosed herein.

Installing a corporation stop on a main pipe or the like may advantageously be accomplished by using a suitable drilling and tapping machine as known by those skilled in the art (represented in simplified form in the Figures by reference no. 38). Specifically, a drill and tapping machine saddle 30 may be secured on a main pipe 20 whereby the corporation stop saddle 14 is between the machine saddle 30 and the main pipe 20, and a gasket 50 is between the corporation stop saddle 14 and the main pipe 20. The main pipe 20 may then be drilled and tapped using the drilling and tapping machine 38 to form a threaded opening 60 through the main pipe 20. The corporation stop body 12 is then inserted into a corporation stop saddle cylindrical opening 70 and, while securing the corporation stop saddle 14 against rotating, the corporation stop body 12 is rotated to screw it into the main pipe threaded opening 60 whereby the corporation stop body 12 when tightened bears against the shoulder 64 of the corporation stop saddle 14 to secure the gasket 50 around the central opening and between the corporation stop saddle 14 and the main pipe 20. Finally, the drilling and tapping machine including the drilling and tapping machine saddle 30 may be removed.

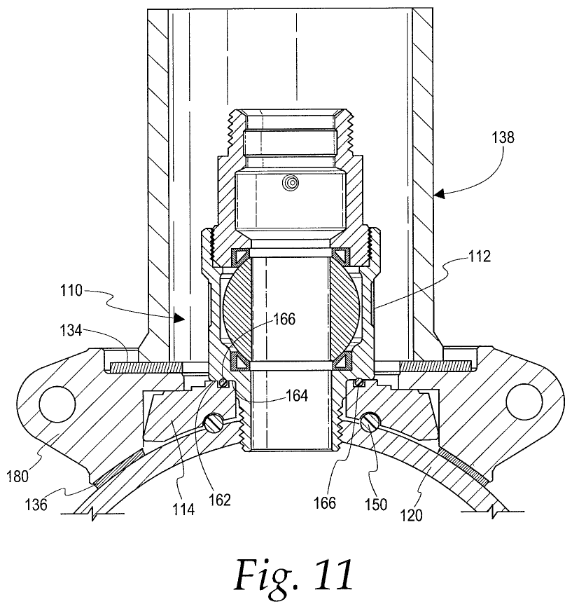

Another form of the invention disclosed herein is illustrated in FIG. 11. (Note that in FIG. 11 and its description, reference numbers to comparable elements in FIG. 3 are used by adding 100—e.g., stop saddle 14 in FIG. 3 is stop saddle 114 in FIG. 11). This fitting 110 includes a machine saddle 180 which holds the corporation stop saddle 114 in place on the pipe 120 during the drilling, tapping, and installation of the corporate stop body 112, with the machine saddle 180 removed after installation of the corporation stop body 112. As can be seen by comparing the structures of FIGS. 3 and 11, the gasket(s) 66 vs. 166 are differently located, with the gaskets 66 of FIG. 3 positioned between the axially oriented stop body inlet 24 and stop saddle bore 70 vs. the gasket 166 of FIG. 11 which is between a radially extending face 162 of the stop body 112 and the radially oriented stop saddle shoulder 164.

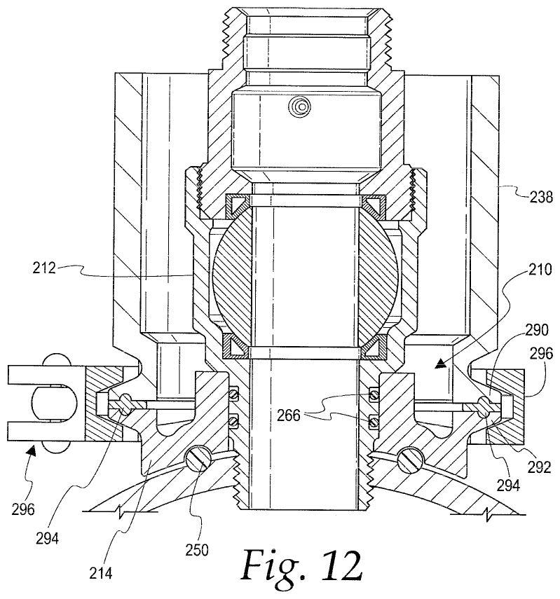

Yet another form of the invention disclosed herein is illustrated in FIG. 12. (Note that in FIG. 12 and its description, reference numbers to comparable elements in FIG. 3 are used by adding 200—e.g., stop saddle 14 in FIG. 3 is stop saddle 214 in FIG. 12). This fitting 210 may be advantageously used with a drilling and tapping machine in which the tapping machine need not conform to the contour of the main pipe 220. Rather, the tapping machine 238 has an annular lip 290 secured on an annular lip 292 of the corporation stop saddle 214 with a gasket 294 therebetween. A suitable quick clamp 296 (e.g., a clamshell) may be closed around the lips 290, 294 to secure the stop saddle 214 to the tapping machine 138 during drilling and tapping, with the gasket 294 preventing leaking between the lips 290, 292 during such operations. It should be appreciated that this structure would eliminate the need for a separate machine saddle during installation of the corporation stop 212.

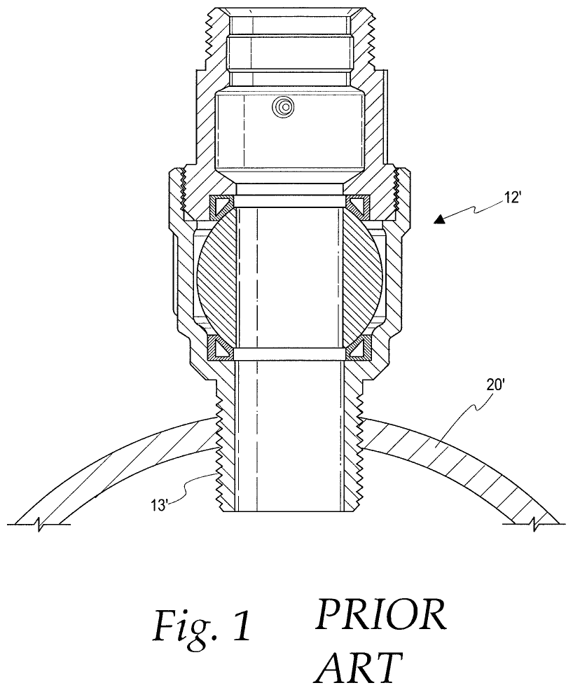

It should be appreciated that corporation stops installed with even small corporation stop saddles 14, 114, 214 as variously described herein provide a robust connection with a contact area around the corporation stop making the fittings 10, 110, 210 more resistant to adverse bending than a traditional corporation stop without such a saddle (compare FIG. 1 with the fitting including the saddle 14 in FIG. 3).

It should also be appreciated that fittings 10, 110, 210 of the present invention are not intended to limit use to tapping of pressurized main pipes. A person skilled in the art will recognize that the corporation stop bodies 12, 112, 212 may be installed with simple tools on an unpressurized main pipe or other mains requiring corporation stops. It should still further be appreciated that such fittings 10, 110, 210 can be used with a wide variety of drilling and tapping machines, with machine saddles configured to suitably seal with the machine to prevent leaking during drilling and tapping (e.g., see gaskets 34, 36 in FIG. 4A, gaskets 134, 136 in FIG. 11, and gasket 294 in FIG. 12). For example, the fitting 110 and machine saddle 180 of FIG. 11 is compatible with well-known, standardized machinery such as the Mueller B-101 Drilling and Tapping Machine and Reed Mfg Co TM1100 Direct Tapping Machine.

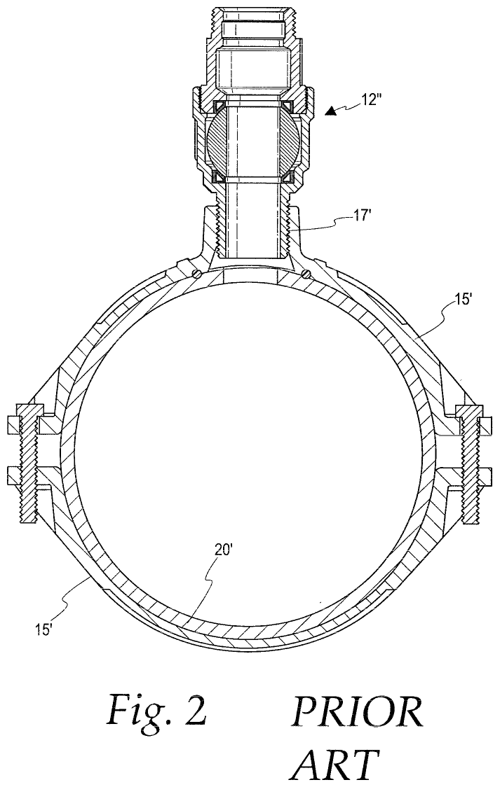

Still further it should be appreciated that fittings 10, 110, 210 with gaskets (e.g., gaskets 50, 66 in FIG. 3, gaskets 150, 166 in FIG. 11, and gaskets 250, 266 in FIG. 12) eliminates the reliance on threads for sealing (see, e.g., the prior art illustrated in FIGS. 1 and 2). Taps wear out and produce poor threads, and pipe walls may have imperfections that prevent sealing. Further, the fitting 10 of the present invention provides potentially less stress on the main pipe.

Still further, the fitting 10 of the present invention may require fewer pieces and a smaller assembly compared to a traditional saddle and corporation stop assembly.

What is claimed is:

1. A fitting for a corporation stop on a main pipe adapted to secure in a threaded opening in the main pipe comprising:
a corporation stop body having
an inner passage between an inlet and an outlet end,
a threaded outer surface on the inlet end, said thread being centered on an axis,
an outer shoulder facing the inlet end, and
an annular outer surface adjacent to and coaxial with the threaded outer surface;
a corporation stop saddle around said corporation stop body annular outer surface whereby said corporation stop body and corporation stop saddle are rotatable relative to each other around said axis, said corporation stop saddle having a face around said corporation stop body adapted to fit the contour of a main pipe;
a first seal around the corporation stop body on said corporation stop saddle face; and
a second seal between said corporation stop body annular outer surface and said corporation stop saddle;
wherein when said corporation stop body is screwed into a main pipe threaded opening, said corporation stop body outer shoulder presses said corporation stop saddle axially against the main pipe to secure against leaking past the first seal.

2. The fitting of claim 1, wherein said first and second seals are gaskets.

3. The fitting of claim 2, wherein said first and second gaskets are O-rings.

4. The fitting of claim 1, further comprising a valve in the corporation stop body inner passage between said inlet and outlet ends.

5. The fitting of claim 1, wherein said corporation stop saddle is securable against rotation around the axis when said corporation stop body rotates around said axis.

6. The fitting of claim 1, wherein said corporation stop body thread is straight.

7. The fitting of claim 1, wherein said corporation stop body thread is tapered.

8. A main pipe with at least one fitting according to claim 1 secured thereto.

9. The fitting of claim 1, further comprising an annular recess in said corporation stop saddle face wherein said first seal is in said stop saddle face annular recess.

10. A method of installing a corporation stop body on a main pipe using a drilling and tapping machine, comprising the steps of:
securing a drilling and tapping machine saddle on the main pipe with
a corporation stop saddle between the machine saddle and the main pipe,
a gasket between the corporation stop saddle and the main pipe, and
said corporation stop saddle having a cylindrical opening;
drilling and tapping the main pipe using the drilling and tapping machine to form a threaded opening through the main pipe;
inserting the corporation stop body into said corporation stop saddle cylindrical opening;
while securing the corporation stop saddle against rotating, rotating the corporation stop body to screw it into the main pipe threaded opening whereby said corporation stop body when tightened bears against a shoulder of the corporation stop saddle to secure the gasket around the central opening and between the corporation stop saddle and the main pipe; and
removing said drilling and tapping machine including the drilling and tapping machine saddle.

11. The method of claim 10, further comprising the step of providing at least one gasket between the corporation stop saddle cylindrical opening and said corporation stop body in said corporation stop saddle cylindrical opening.

12. A method of installing a corporation stop body on a main pipe using a drilling and tapping machine, comprising the steps of:
connecting a drilling and tapping machine and a corporation stop saddle on the main pipe with a gasket between the connection of the corporation stop saddle and the drilling and tapping machine, wherein said corporation stop saddle has a cylindrical opening;
drilling and tapping the main pipe using the drilling and tapping machine to form a threaded opening through the main pipe;
inserting the corporation stop body into said corporation stop saddle cylindrical opening;
while securing the corporation stop saddle against rotating, rotating the corporation stop body to screw it into the main pipe threaded opening whereby said corporation stop body when screwed into the main pipe threaded opening bears against a shoulder of the corporation stop saddle to secure the gasket around the central opening and between the corporation stop saddle and the main pipe; and
removing said drilling and tapping machine.

13. The method of claim 12, further comprising the step of providing at least one gasket between the corporation stop saddle cylindrical opening and said corporation stop body in said corporation stop saddle cylindrical opening.

14. The method of claim 12, wherein said connecting step comprises clamping overlapping lips of said machine and said corporation stop saddle together with a gasket secured between said overlapping lips.
